(19) United States
(12) Patent Application Publication
(10) Pub. No.: US 2007/0016871 A1
(43) Pub. Date: Jan. 18, 2007

(54) Method of visualising data

(76) Inventor: John Thomas Magnifico, Leichardt (AU)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/473,684

(22) Filed: Jun. 22, 2006

Related U.S. Application Data
(63) Continuation-in-part of application No. PCT/AU04/01801, filed on Dec. 22, 2004.

(30) Foreign Application Priority Data
Dec. 22, 2003 (AU) 2003907050

(51) Int. Cl. G06F 3/00; G06F 7/00; G06F 17/00

(52) U.S. Cl. 715/764; 715/530; 707/102

(57) ABSTRACT

A method for visualising data on a computer screen is provided, where the data is held in any type of computer database. The data is displayed in the form of discrete visual objects that represent records in the database, arrayed about an x- and a y-, and optionally a z-axis. The user selects one, two or three attributes of the data to be represented about the axes, and each visual object displays and represents the remaining data attributes for each record. The user can select a data object and drill down to display the data elements for that record, and can further interact by changing the data, if desired. The appearance of the visual object can be changed, to represent some attributes, in various ways. One attribute is preferably a measure of time. In this situation, the display may be animated to show trends occurring over time, or to provide a forecast.

The subject application is filed under 35 USC § 111(a) as a continuation-in-part of presently pending international application Ser. No. PCT/AU2004/001801 filed on Dec. 22, 2004 and designating the United States, said international application having a claim to priority to Australian Application Ser. No. 2003907050 filed Dec. 22, 2003, said priority application incorporated herein by reference in its entirety.

### TECHNICAL FIELD

The present invention relates generally to a method of visualising data, on a data display monitor or computer screen. It can visualise the data from any database or information source. Data can be represented on the monitor, and optionally amended using the visualisation method. The invention provides an ability to view a “snapshot” of the information and then, if desired, to drill or narrow down to see more detail. The method operates in a “top down”, rather than a “bottom up” approach, starting from a overview display of complex data, and allowing for more details to be displayed, as the need arises.

### BACKGROUND

Every organisation has business goals and objectives that they wish to achieve. The determination of the extent to which these goals are achieved normally relies on the organisation's own data systems in order to track, monitor and ultimately report on performance. Many organisations and their staff find that their database management systems are generally difficult and unrewarding to use and cumbersome to maintain. The benefits of such systems are usually not obvious to its users. This in turn reduces the potential usage of the systems, and the quality of the information entered then suffers.

One solution to this problem is to incorporate the data entry mechanism within a standard form or to provide a spreadsheet like interface. This provides some improvement, by means of providing better application design, such as a user-friendly interface using appropriate colours, better logic in field layouts, and so on. But this has had little effect on the end user experience, and hence their acceptance and use of such systems is lower than it can be. Not only are such systems cumbersome, but potentially useful information is not always obvious to a user. An ideal reporting or data analysis tool, for business intelligence for example, would generally require separate data abstraction and display as well as some data analysis. The experience of using existing such systems is often unrewarding due to a generally user-unfriendly interface. This can bring about the result of low quality of data stored in such systems. The consequences of having low quality data will mean that any analysis or reporting from this data will tend to result in low quality output and inaccurate results. These disadvantages discourage use of the system causing a lack of historical information, and leading to poor forecasting and predictive capabilities as a result.

These problems may be ameliorated or overcome by the present invention, which can also provide a useful alternative to existing approaches.

### DISCLOSURE OF THE INVENTION

The present invention, in one broad form concerns a method of visualising data on a computer monitor, where the data resides in a database on a computer that is in communication with the monitor. The database comprises a plurality of records, with each of the records comprising a plurality of data elements stored in the database that correspond with a plurality of attributes for each of the records. The method comprises the steps of, (a) analysing or interrogating the database, and providing means both to allow a user to select a sub-set of records, and to select a sub-set of attributes for the records, to display upon the computer monitor. The user chooses one of the attributes to be displayed along an x-axis, and chooses another of the attributes to be displayed along a y-axis, and chooses one or more attributes from among the remainder of the sub-set of attributes to be represented and displayed in the form of a discrete visual object. (b) The method displays the data on the monitor arranged according to the sub-set of attributes in the form of a plurality of discrete visual objects arrayed about the x- and y-axes. Each of the visual objects representing a record in the sub-set from the database. (c) The method provides means for the user to select any one or more of the visual objects. Upon selection, at least some of the data elements for the attributes represented by the selected visual object are displayed. There are means provided for optionally allowing the user to edit any of the data elements. (d) The method also provides means to allow step (a) to be repeated with a different choice of attributes.

Preferably, the user can move any one or more of the displayed visual objects in relation to the axes, and the data elements that correspond to the attributes are changed at least temporarily for the records that correspond to the moved visual objects. In this case, preferably the changes are reversible or temporary.

The method may preferably have additional means to allow the determination of boundaries for the attributes that are chosen to display along the axes, the boundaries being displayed visually on the monitor. In this case, ideally the boundaries may display in the form of one or more lines, or one or more delineated areas, or both, arranged about the axes.

Another preferred feature is to allow for a further attribute to be chosen that is to be displayed along a z-axis, and the data is displayed on the monitor in the form of discrete visual objects arrayed about the x-, y- and z-axes with a 3-dimensional appearance. A further option is for the method to have means for a user to choose an appearance of the discrete visual objects that distinguishes or characterises at least one of the attributes it represents, either initially or interactively at any time according to the user's wishes. There may also be means for a user to choose an appearance of the discrete visual objects that displays at least one other of the attributes it represents as part of the visual object.

Preferably, one of the attributes that is chosen to be displayed along the axes represents a measure of time. There may also be means to animate the display, so as to replay the data changes over time at a rate configurable by the user that the user can perceive comfortably. In this situation there may also be means to allow additional data to be temporarily added to the database by the process of extrapolation, to display a forecast. Preferably, there may be further means provided to allow a user to filter the visual objects according to a range determined by a user for one or more of the attributes, or to suppress the appearance of the visual objects, according to one or more of the attributes determined by the user.

The invention also concerns a software application for use on a computer system, which implements the methods outlined above.

### BRIEF DESCRIPTION OF DRAWINGS

The invention is now discussed with reference to drawings, where:

FIG. 1 is a general diagram of the method of the present invention;

FIG. 2 is an example of some indicative data;

FIG. 3 is a graphical display of that data according to a previously known approach;

FIG. 4 shows an example of one embodiment of the invention also showing an interactive data editing capability, and also showing boundary shading;

FIG. 5 shows another representation of the present invention, and an interactive data querying capability;

FIG. 6 shows an expanded view of a portion of the query function from FIG. 5;

FIG. 7 shows a generalised application of the invention with a time component along the x-axis;

FIG. 8 shows another more realistic example, similar to that of FIG. 7;

FIG. 9 shows another embodiment showing visual object with an additional attribute display graphic;

FIG. 10 shows an expanded view of one object from FIG. 9;

FIG. 11 shows another embodiment with a time animation capability; and

FIG. 12 shows an expanded view of the animation function from FIG. 11.

### BEST MODES FOR CARRYING OUT THE INVENTION

Generally, the data from any database, such as one for a business system, will be depicted as discrete visual objects or entities, on the computer monitor.

The invention concerns visualising data on a computer monitor, where the data resides in a database on a computer. The computer drives the computer monitor. By “computer monitor” is meant any display medium or screen associated with any type of computer that may be interactive with a user in some manner. It is preferably a computer display monitor, and preferably there is means for a user to interact with the display, by operating a mouse or tracking apparatus that operates a cursor on the screen, or by touching the screen, or otherwise, so as to be able to interact with the images so displayed. Any type of computer, or computing device with a microprocessor may be involved, such as standard computers, personal computers, or devices with computing capabilities, such as personal assistant electronic devices, handheld devices, or even mobile telephones, if it has a screen and sufficient computing ability.

The data is held in a database, which comprises a number of records, each record having one or more data elements that correspond to various attributes concerning each record. For example, a database may hold information about a number of business proposals, and each record represents one proposal, and the data elements may comprise text data, for storing names and notes, numeric and date data elements for storing cost estimates and dates relating to the business proposals, for instance. The meaning or purpose of the data elements constitutes the attributes for the data.

Any type of database may be utilised in the invention. Actual databases such as object oriented or relational databases like SQL databases, or other arrangements of data on computers including spreadsheets, word processing or XML documents and the like may be used, if it meets the requirements for storing data, so that at least some aspects of the data can be presented graphically on a computer monitor.

The database is analysed, which may involve making a local copy of it, operating with the software application of the invention, or else it may be utilised as is. Changes created by the method of the invention may occur to the original data, or else may be made to a copy of the data, or the changes may be stored temporarily or reversibly.

The attributes are selected, so that one, two or three of them display along the x-, y-, and z-axes, and the remainder of the selected attributes are displayed as a discrete visual object. This visual object may take any appearance, but is preferably an easily recognisable item, such as a geometric shape, or an image, such as one that may have an appearance that matches the data it represents. For example, photographs of staff may be used, if the object represents each sales member and their sales over time are displayed along the x/y axes. The object may preferably be distinguished according to one or more of the attributes that they represent, or the values for these attributes, for instance. They may take on different shapes or colours or sizes, for example. They may be animated, or change, or even produce music or sounds when selected.

The x- and y-axes may be displayed, or may be invisible, or may swap between both states, depending on the user's preferences and the type of data. If the absolute values for the data elements are not especially important, the axes do not need to be displayed. The axes may show a scale, or not, or swap between these options, according to the user's wishes. These x- and y-axes may the oriented in any direction; they are not necessarily horizontal and vertical.

The method of the invention may be implemented to operate on a computer system using any suitable programming language or approach. However, it is preferred to program this application using the “Squeak” programming language, which is an implementation of the “Smalltalk” language, both of which are object-oriented, dynamically typed, reflective programming languages. Also, “Squeak” can be combined with the “Morphic” application that is a direct-manipulation user interface construction kit, in order to construct a user interface. Alternatively, the software application may be programmed using the “Croquet” language which is similar to “Squeak”, but with improved 3-dimensional display capabilitites, which can be combined with the “Tweak” application to create a user interface. A programming langauge that has good handling capabilities for graphics is preferred.

Any existing database or data repository may be utilised with the invention, such as a customer relationship management (CRM) system, enterprise resource planning (ERP) system, business intelligence system supply chain management (SCM) system, and other accounting and financial systems. The invention may be used to visualise the relevant information in the organisation in a concise and user friendly format. This will provide benefits to the organisation.

The invention can have many applications, particularly in regard to some of the areas of high importance to organisations such as: corporate performance management (CPM); balanced scorecard (BSC) (a popular performance management methodology); European foundation for quality management (EFQM); Economic value-added/valued based management (EVA); activity based costing (ABC), and activity based management (ABM); intangible asset management; opportunity management system (OMS) tool for organisations, particularly for sales teams to effectively manage sales opportunities. An OMS is a combined business planning, forecasting and account management system. Increased accountability is being required for forecast accuracy and pipeline visibility from executive management, which tends to make the OMS the functional foundation component for sales applications. Other applications include: business intelligence (BI), to increase organisational efficiency and effectiveness by streamlining the data flow, making it faster and more accessible; business activity monitoring (BAM) monitoring business events in real time and delivering alerts and exceptions directly to users to enable them to react more quickly to changes in the business environment. Other applications include: any project management and coordination tool, to effectively manage projects; any knowledge management tool, to easily visualise intellectual property and staff-based knowledge experts within an organisation; as well as any other system that is governed by a process and hence has some form of workflow or process.

To assist with understanding the invention, reference will now be made to the drawings that show an example of the invention.

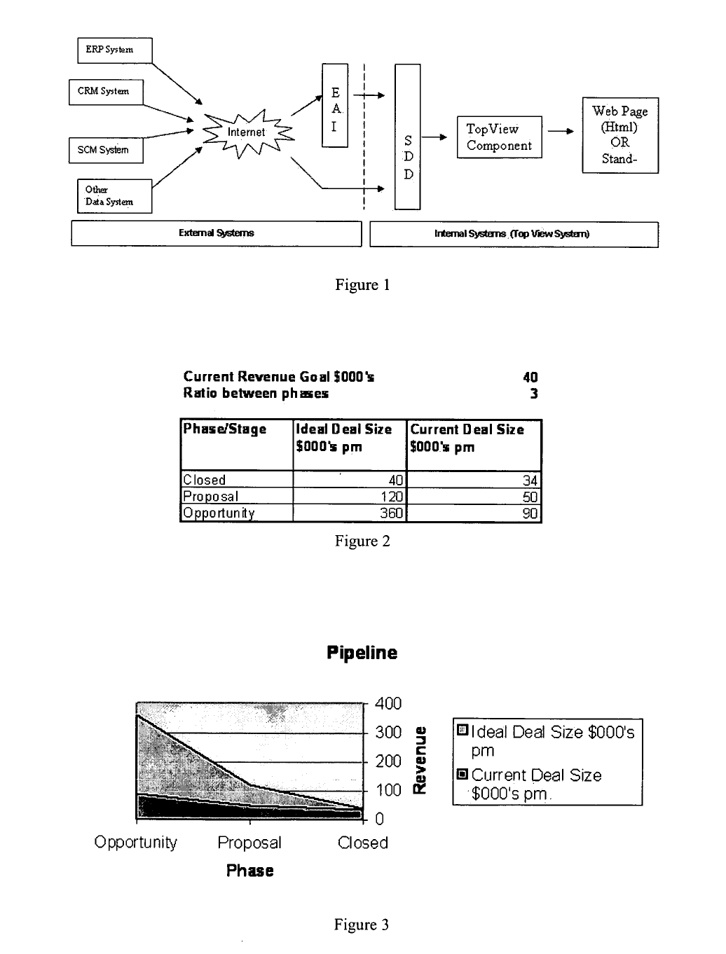

One form of the architecture of the method of the invention may look something similar to that depicted in FIG. 1. Various applications such as the ERP, CRM, SCM or other data systems in the organisation may be the source of the data. These external systems may be accessed over the computer network, or via the internet or held directly on a computer such as a workstation or personal computer using an enterprise application integration (EAI) system. The components of a software application that implements the method of the invention are internal components.

There may be a data component that contains the raw data or information received by the various external systems, which is stored and used by invention. Various data sources may be utilised, such as databases, spreadsheets including those created from “csv” flat files, web services including XML documents, along with any other suitable sources of data such as email systems, knowledge management systems, etc. The data component may also utilise archived databases previously generated and used by the invention. A standard data definition (SDD) is part of this component for current as well as any historical information used in extrapolation and predictive algorithms. It also defines the generic interfaces needed by the other components.

There is also a “topview”, or overview, component that generates or constructs the visual objects that can be displayed, in accordance with the present invention, that allows a user to drill down to data within these objects. These visual objects can appear on a display for a web page or directly from a stand-alone application or system. There will be a number of views constructed based on the various selection options presented to the end-user. This is based on the degrees of freedom allowed from the above data schema.

Using the concept of a “pipeline” or “funnel”, then various ways of representing the data are available. A pipeline facilitates the visualisation of data and information flow or in the case of business processes represents workflow. This component will itself comprise other components.

There may also and preferably be a user interface component that provides means to allow a user to interact with the system and its various features. There may preferably also be a graphics component in order to generate the graphics and images for use in the method of the invention. In particular the discrete visual objects may be generated through this component, which may be in the form of “Morphic” or “Tweak” objects, jpeg, GIF, etc format pictures that can describe or characterise aspects of the data provided. There may also be an animation component, where each graphics component may be animated on the display according to where it is positioned over a specific period in time. The animation component would combine multiple instances according to time of the graphics module. Preferably, it may use “GIF” animation, “GIF89”, “dHTML”, “Flash”, or “Shockwave”, or other possibilities for the animation.

There may also preferably be a reporting component that is capable of generating any report needed by a user. Any report writer application may be used, in conjunction with the method of the invention. These reports are based on the objects being displayed or on the data that these objects represent, or on a combination of these, and may also display the information generated in the format created by the invention, or in any other appropriate format, such as one exportable to other applications.

There may also preferably be a verification or security component that provides a secure authentication and login capability, so that only authorised personnel may have access to the system. There may also be a standard authorisation process with a hierarchical structure. Various security levels for users may be defined, with unique attributes that will allow or restrict them from certain parts of the system. This will effect what information a particular user can have access to, and how they can and cannot interact with the system.

There may also preferably be an alert component that has an ability to send various alerts as a result of certain condition being met within the system via a number of standard messaging or other mechanisms such as email, SMS, WAP, etc. These alerts may be bi-directional, being sent to the users and from the users.

Referring to FIG. 1, information will be aggregated from an external system, such as ERP, CRM, SCM, spreadsheets, databases, etc across the internet for example, by an enterprise application integration system (EAI) or directly. EAI systems are inexpensive and are readily available in the marketplace. The invention in a preferred form, may have its own persistence engine (ie, database) so it can be used completely independent of any other system, if required.

The data will then be placed in an appropriate format using the standard data definition module that incorporates all relevant interfaces. The invention will then use this data to develop a graphical representation for this information, which may be incorporated into either a web page or into a stand-alone application or system. This information may comprise important data for a particular organisation and it can then be displayed to users, in combination with a graphic image that represents the desired or ideal outcomes, so serving as a comparison. This may be based on the organisation's goals and objectives, such as key performance indicators, in relation to the source of data being displayed.

The invention has the ability to graphically represent a set of static or dynamic data, in a concise and highly visual manner. A very simple example is presented in FIGS. 2 and 3 using common spreadsheet and graphical techniques. As can be seen from FIG. 2, the data in this example represents some business opportunities that an organisation has (on the left), and business that the company has closed (on the right). FIG. 3 shows how this information would traditionally be displayed in a graphical manner.

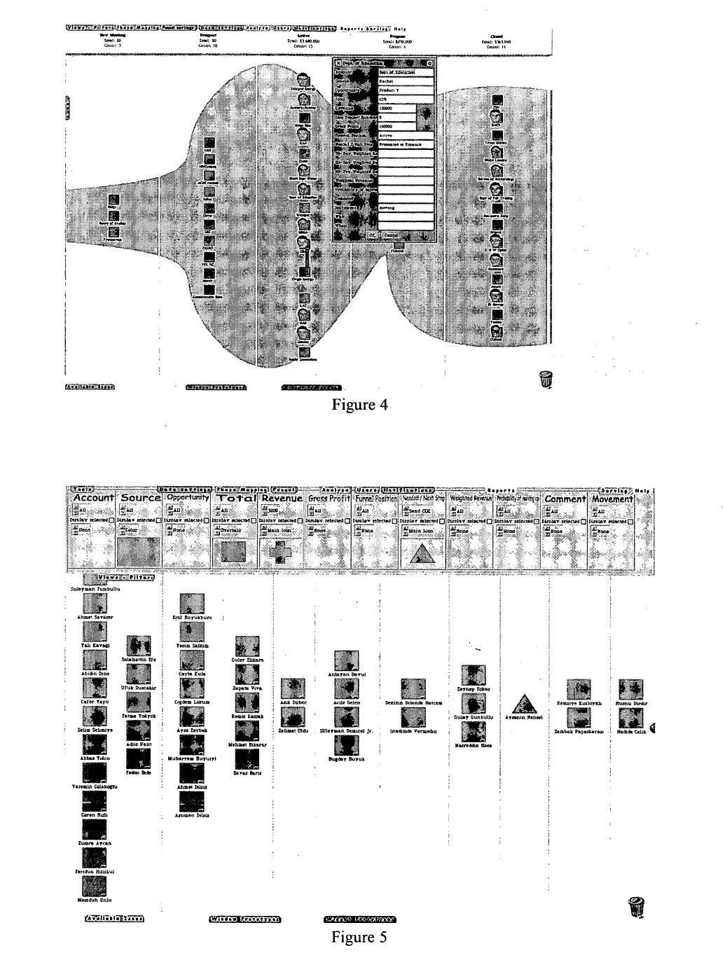

In contrast the method of the invention can be used to display an ideal representation of what the data should look like, as shown in FIG. 4. In this example, a shaded area represents the “key performance indicators” that an organisation may have. Optionally, the invention can retain and eventually learn from its historical data to help define what this “ideal” curve should look like.

The method of the invention is particularly useful when used to visualise data that defines some kind of process flow, or is based on a definable process, especially one which has a time component. In the example of FIG. 4; “opportunities”, “proposals”, and “closed” all comprise attributes of the data that can represent this flow, which would relate to the general sales process within the organisation.

The visualisation will substantially reflect rows of data from tables in a database, or individual records, or combinations of such information as an object or entity. These objects would have a number of attributes that are defined by data from the individual records within the data source.

The attributes that are used to construct the visual objects and their locations along the x- and y-axes can be selected directly from the database, and the raw data used. Alternatively, the attributes may be modified or transformed using any technique. For example, multiple attributes may be combined with each other. They may also be translated into other data formats, and so forth.

It is another aspect that the method of the invention can also be used to update the data in the system, in an interactive manner. The data entry and editing capability may, for example, involve dragging the object from one location (or phase) to another. This would change the time attribute for the data, and the actual values for dates when business opportunities should occur, for instance, and subsequently update the database. Another alternative, would be that the user could double-click on the visual object and modify/change its values and attributes. An example of this is shown in FIG. 4. By double-clicking on the object that represents a specific record in the database, a table is then displayed showing the attributes and the data element values for that record. The user may then alter these values. The arrangement on the monitor may then change to reflect these changes, if this is appropriate, such as if the changed attributes are those that have been chosen by the user previously to be used in the display. As mentioned previously, the changes to the data altered in this manner may or may not be updated permanently in the original database.

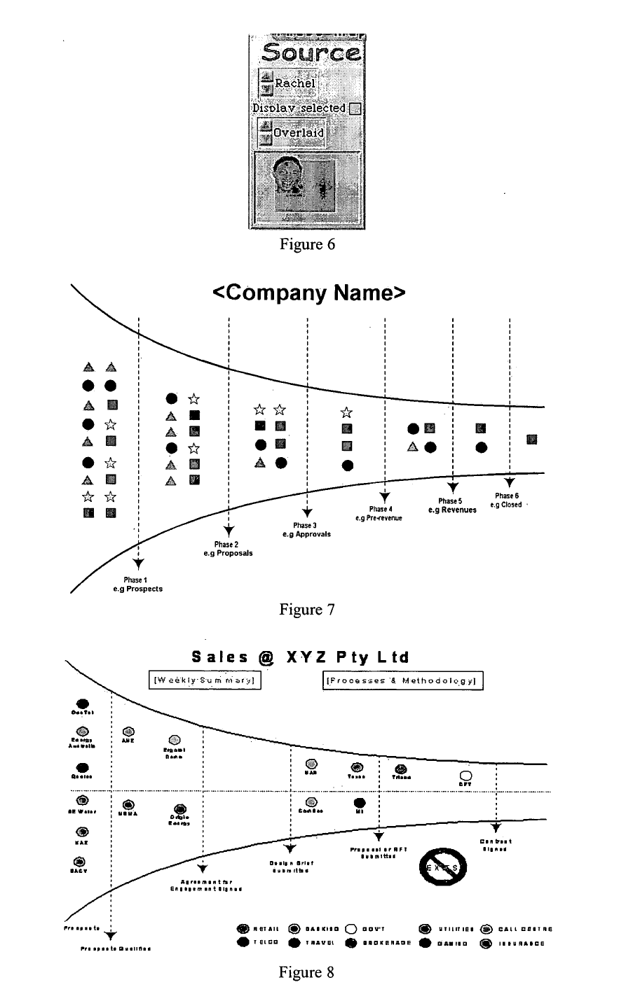

Another preferred feature of the invention is a visual query facility, which can enable a user to visualise different skews on the information available. This may be a filtering type function on various fields in the data set. FIGS. 5 and 6 depict an example how various fields have been assigned different shapes, which are in turn indicated on the display. As shown in FIG. 5, a menu allows the attributes or each visual object to have its shape, colour, or other aspect of its appearance selected. The appearance may be allocated automatically initially, and then changed by a user at a later time. The menu also allows for the display to be filtered.

An expanded view of a portion of the menu is shown in FIG. 6. One staff member “Rachel” has her visual object changed, by double clicking on the lower icon for instance, and to select a shape for one of her attributes to be a square, and also to select a colour to represent another aspect. Her object has been changed to display her photo. The “Display selected” checkbox can remove her data from the display. A range of values for some attribute of her data, such as sales figures, may also be selected, to limit the data for display.

The invention creates a view of the information as depicted in general terms in FIG. 7. FIG. 6 shows a simple generic depiction in the form of a “pipeline”, which depicts six time phases (process stages) and a number of objects with different visual characteristics. A “pipeline” or funnel has been used in this instance because it is reasonably straightforward to interpret and is very suitable for describing process flows. Essentially, there is a process or time flow from left to right. The ideal curve is the solid lines that represent the boundaries of the funnel. The visual objects will more than likely be placed within the boundaries for the “ideal” curve. This may indicate that an organisation is likely to have a shortfall in business revenue in this example, relative to its current goals and based on past organisation performance.

FIG. 7 is a more realistic example of what data would be defined by the invention. In this example, colour, shading, or some other visual features, may be used to represent each different type of “Industry” which would be an attribute or field described in the SDD.

A user can edit the data by moving a visual object within the pipeline to a different time (or phase) position, of according to any number of rules and/or choices. These rules would be developed for each situation and data set. Otherwise, a user could experiment by moving an object about the display to determine the results. Put simply depending on what data is originally available the objects could be arranged in a great variety of ways. The pipeline boundaries are preferably indicative, of the ideal or goal, and objects can fall outside of them in the display, if the data reflects this.

Any variety of arrangements can be used to depict the data. The user chooses which data attributes are represented on the x- and y-axes, and then the visual objects are displayed. Some choices for the present Example include, selecting by value, where the lower value is placed lower on pipeline; by probability where a measure of probability is another attribute recoded in the database. Other options include: by age, where objects that are oldest, based on relative time, are placed along the y-axis, within a specific time or project phase; or by order, again preferably within the specific phase, so that the first, second, into a specific phase determines the order on the display. Another option is by area or size so that the size of the underlying value determines the order.

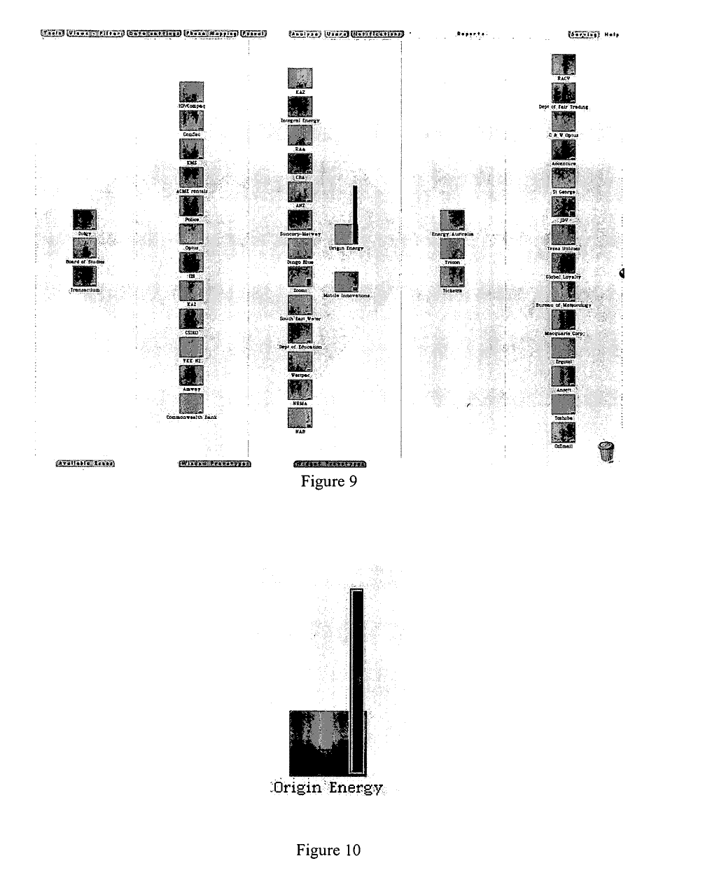

The users may choose alternate fields or data attributes in order to provide a different visualisation of the same set of data. This may be done interactively at any is time, Instead of the time phase being depicted, the names could be grouped alphabetically across the x-axis, from left to right as shown in FIG. 9.

Furthermore, it is another option according to the invention to display other attributes for the records in the database by displaying further visual indications of the data as part of each visual object. As shown in FIGS. 9 and 10, it is possible to superimpose other images on top of the current object to depict extra visual information about that visual object's data attribute or information. FIG. 10 shows an example, taken from the example of FIG. 9, where the value of a particular sales account is shown with a bar-like chart being superimposed on the existing visual object. The additional visual information is preferably superimposed or attached to the original object, but it may be physically separated, or otherwise arranged, so long as it appears to be part of, or somehow connected with, in the mind of the user, the original object.

It is another preferred option to display third attribute, by depicting the display to appear as a 3-dimensional arrangement. The appearance remains 2-dimensional in reality on a monitor, but the appearance of a third (depth) dimension is implied by using visual techniques to represent depth and perspective. This 3-D visualisation is used to show another attribute of the object's dataset as depth, along the z-axis, seemingly into or out of the plane of the screen.

In FIG. 8, the values running across the screen, left to right (x-axis) have been visualised on the basis of time or project phase. The position of the objects running up the screen, from bottom to top (y-axis) have been allocated randomly simply by the space available on the screen. The invention can visualise the information provided in many different ways, by changing the reference data. Instead of having time represented on the x-axis, the objects could instead be in alphabetical order. The result would be a different grouping of objects, as shown in FIG. 9. This new grouping can trigger unexpected correlations or other useful ideas to users.

In our current sales-orientated example, the grouping of visual objects can reflect the value of these entities as potential customers. This will allow the staff to quickly focus on gaps in current and future revenues and hence contribute to enhancing the organisations performance, for example.

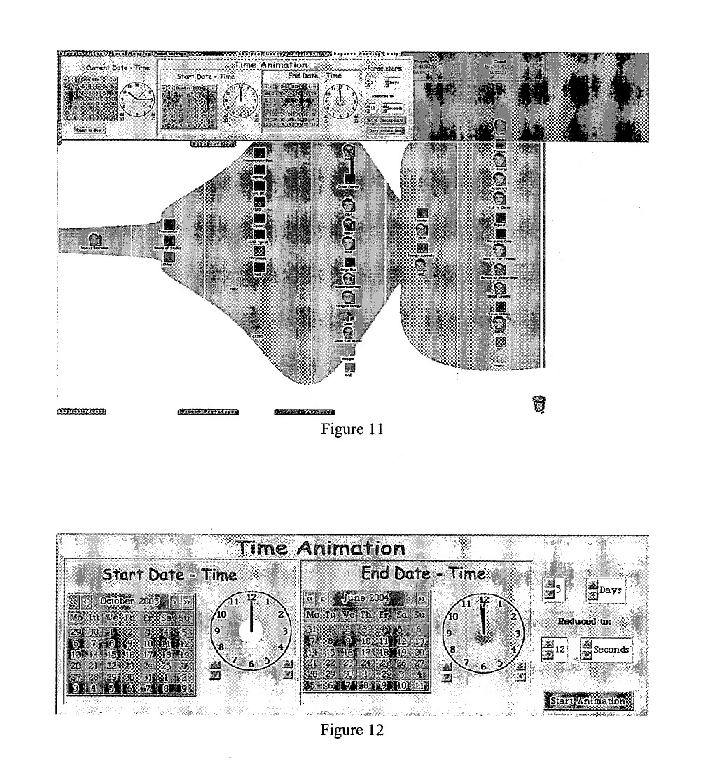

The Example in FIG. 11 shows another aspect of the invention. A menu allows the selection of a time period for data that has a time measure component arrayed about the x-axis, for instance. This time period permits the data to be animated, and the time attribute can be played back to a user at a rate that the user can perceive comfortably. The user can adjust the speed for the animation to suit. The portion of the menu allowing this is expanded in FIG. 12.

Furthermore, if the end time in changed to a value that is beyond the data that is being stored on the database, then the animation can run to show a forecast of further changes over time. Any suitable extrapolation algorithm may be utilised, to display the forecast, in this situation. The method for this aspect of the invention calculates and stores additional data, temporarily, and then displays this for the additional time period selected.

1. A method of visualising data on a computer monitor, wherein said data resides in a database on a computer in communication with said monitor, and said database comprises a plurality of records, with each of said records comprising a plurality of data elements stored in said database that correspond with a plurality of attributes for each of said records, said method comprising the steps of,
(a) analysing said database, and providing means to allow a user to select a sub-set of records, and means to select a sub-set of attributes for said records to display upon said computer monitor, whereby said user chooses one of said attributes to be displayed along an x-axis, and chooses another of said attributes to be displayed along a y-axis, and chooses one or more attributes from among the remainder of said sub-set of attributes to be represented and displayed in the form of a discrete visual object,
(b) and displaying said data on said monitor arranged according to said sub-set of attributes in the form of a plurality of discrete visual objects arrayed about said x- and y-axes, whereby each of said visual objects representing a record in said sub-set from the database,
(c) providing means for said user to select any one or more of said visual objects, whereby upon selection, at least some of the data elements for the attributes represented by said selected visual object are displayed, and providing means for optionally editing any one or more of said data elements, and
(d) providing means to allow step (a) to be repeated with a different choice of attributes.

2. The method of claim 1, wherein means are provided to allow said user to move any one or more of said displayed visual objects in relation to said axes, and the data elements that correspond to said attributes are changed at least temporarily for the records that correspond to the moved visual objects.

3. The method of claim 2, wherein said changes are temporary.

4. The method of claim 1, which has additional means to allow the determination of boundaries for the attributes that are chosen to display along said axes, and said boundaries are displayed visually on said monitor.

5. The method of claim 4, wherein said boundaries display in the form of one or more lines, and/or one or more delineated areas, arranged about said axes.

6. The method of claim 1, wherein a further attribute is chosen that is to be displayed along a z-axis, and said data is displayed on said monitor in the form of discrete visual objects arrayed about said x-, y- and z-axes with a 3-dimensional appearance.

7. The method of claim 1, which has means for said user to choose an appearance of said discrete visual objects that distinguishes at least one of the attributes it represents initially, or interactively at any time.

8. The method of claim 1, which has means for a user to choose an appearance of said discrete visual objects that displays at least one other of the attributes it represents visually as part of said visual object.

9. The method of claim 1, wherein one of said attributes that is chosen to be displayed along said axes represents a measure of time.

10. The method of claim 1, which has means to animate the display, so as to replay the data changes over time at a configurable rate that a user can comfortably perceive.

11. The method of claim 9, which has means to allow additional data to be temporarily added to the database, by a process of extrapolation, to forecast further changes with time.

12. The method of claim 10, which has means to allow additional data to be temporarily added to the database, by a process of extrapolation, to forecast further changes with time.

13. The method of claim 1, wherein further means is provided to allow a user to filter said visual objects according to a range determined by said user for one or more of said attributes, or to suppress the appearance of said visual objects, according to one or more of said attributes determined by said user.

14. The method of claim 1, which has further means to generate a report of the visual object displayed, and/or the data represented by said objects.

15. A software application for use on a computer system, which implements the method of claim 1.
